(19) United States
(12) Patent Application Publication
(10) Pub. No.: US 2015/0103094 A1
(43) Pub. Date: Apr. 16, 2015

(54) REGION-DEPENDENT COLOR MAPPING FOR REDUCING VISIBLE ARTIFACTS ON HALFTONED DISPLAYS

(71) Applicant: QUALCOMM MEMS Technologies, Inc., San Diego, CA (US)

(72) Inventors: Haitao Xue, Santa Clara, CA (US); Manu Parmar, Sunnyvale, CA (US); Jeho Lee, Palo Alto, CA (US)

(21) Appl. No.: 14/296,200

(22) Filed: Jun. 4, 2014

Related U.S. Application Data
(60) Provisional application No. 61/889,746, filed on Oct. 11, 2013.

(51) Int. Cl. G06T 11/00; G09G 5/02

(52) U.S. Cl. CPC G06T 11/001; G09G 5/02; G09G 2320/0666; G09G 2320/0271; G06T 2207/20004
USPC 345/596

(57) ABSTRACT

This disclosure provides systems, methods and apparatus, including computer programs encoded on computer storage media, for displaying high resolution images with reduced visible halftone noise. In one aspect, an image having a plurality of image pixels is displayed on a display device having a plurality of display pixels, by mapping the tone or color of each input image pixel onto the plurality of display pixels by assigning each display pixel a tone or color value in the color space associated with the display device that is in a neighborhood of the tone or color of each input image pixel and appears to have the same perceptual tone or color value as the image pixel and has a lower visible halftone noise. A size of the neighborhood can be selected based on the color gradient in various portions of the image.

### CROSS-REFERENCE TO RELATED APPLICATIONS

This application claims the benefit of U.S. Provisional Application No. 61/889,746 filed on Oct. 11, 2013, titled “REGION-DEPENDENT COLOR MAPPING FOR REDUCING VISIBLE ARTIFACTS ON HALFTONED DISPLAYS,” which is expressly incorporated by reference herein in its entirety.

### TECHNICAL FIELD

This disclosure relates to methods and systems for adaptively applying color mapping to reduce visible halftone noise in displays and more particularly in electromechanical systems based display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Digital images are commonly quantized into a plurality of grayscale or color levels for printing or displaying the digital images on a medium with limited tonescale resolution. Various techniques have been developed to reduce errors associated with quantization and to create the illusion of continuous-tone imagery in printed and displayed images.

Halftoning techniques have been developed to create the illusion of continuous-tone images on display devices that display a finite number of tones (for example, colors). For example, halftoning techniques can be used to display or print high resolution images (e.g. images having 24 bits per pixel, 8 bits per color channel) on a medium (e.g. a display device) having lower resolution (e.g. 2 or 4 bits per color channel). Examples of common halftoning techniques include spatial or temporal dithering and error diffusion.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus capable of adaptive color mapping, the apparatus comprising a display device including a plurality of display elements and a processor configured to communicate with the display device. Each display element is configured to display a plurality of colors in a color space associated with the display device. The processor is configured to process image data of an image for display by the display device. The image data includes a plurality of image pixels. Each of the image pixels is associated with a color value. The processor is configured to divide the image data into multiple blocks. Each of the multiple blocks includes some of the plurality of image pixels. In various embodiments, each of the multiple blocks can have the same size. In some embodiments, the multiple blocks can include at least some blocks having a size of 5×5 pixels.

The processor is further configured to classify each of the multiple blocks of the image data into one of a plurality of image region types. The classification of each block is based at least partly on color gradients between image pixels in the block. For each image pixel, the processor is configured to select at least one color mapping parameter for the image pixel. The color mapping parameter is based at least partly on the image region type that was classified for a block including the image pixel. The processor is further configured to determine a mapped color for a color of each of the plurality of pixels using the color mapping parameter selected for the respective image pixel and display the image on the display device using the mapped colors for the image pixels.

In various implementations of the apparatus the color of each of the plurality of pixels can represent at least one of tone, grayscale, hue, chroma, saturation, brightness, lightness, luminance, correlated color temperature, dominant wavelength and a coordinate in the color space.

In various implementations of the apparatus, the processor can be configured to apply a halftoning algorithm to the mapped colors to display the image. The mapped color for each of the plurality of pixels can be perceptually similar to the color of each of the plurality of pixels. The mapped color for each of the plurality of pixels can have a halftone noise visibility that is less than a halftone noise visibility of the color of each of the plurality of pixels. The mapped color can be within a neighborhood of the color for each of the plurality of pixels in the color space. The neighborhood can have a size equal to a neighbor value D. In various implementations, the color mapping parameter can include the neighbor value D. In various implementations, the color of each of the plurality of pixels can have a value between 0 and 255 and the neighbor value D can have a value between 0 and 4.

In various implementations, the plurality of image region types can include a constant region, a ramp region, and a texture region. A block can be classified as a constant region if the color gradients in the block are zero. A block can be classified as a ramp region if the color gradients in the block are non-zero and have the same sign. A block can be classified as a texture region if the block is not classified as a constant region or a ramp region. For those implementations in which the color of each of the plurality of pixels has a value between 0 and 255 and the mapped color is within a neighborhood of the color, a size of the neighborhood can be equal to 4 in the constant region, equal to 0 in the ramp region, and equal to 1 in the texture region.

Another innovative aspect of the subject matter described in this disclosure can be implemented in a method for adaptively applying color mapping to display an input image with reduced visible halftone noise on a display device having a plurality of display elements. Each display element is configured to display a plurality of colors in a color space associated with the display device. The image data of the input image comprises a plurality of pixels, each pixel of the image data being associated with a color value. The method can be performed in its entirety by a physical computing device. The method comprises dividing the image data into multiple blocks, each of the multiple blocks including some of the plurality of image pixels. The method further comprises classifying each of the multiple blocks of the image data into one of a plurality of image region types. The classification of each block is based at least partly on color gradients between image pixels in the block. For each image pixel, the method further comprises selecting at least one color mapping parameter for the image pixel based at least partly on the image region type that was classified for a block including the image pixel. The method further comprises determining a mapped color for a color of each of the plurality of pixels using the color mapping parameter selected from the respective image pixel; and displaying the image on the display device using the mapped colors for the image pixels.

In various implementations of the method the mapped color for each of the plurality of pixels can be perceptually similar to the color of each of the plurality of pixels. The mapped color for each of the plurality of pixels can have a halftone noise visibility that is less than a halftone noise visibility of the color of each of the plurality of pixels. The mapped color can be within a neighborhood of the color for each of the plurality of pixels in the color space. The neighborhood can have a size equal to a neighbor value D. In various implementations of the method, the color mapping parameter can include the neighbor value D. In various implementations, the color can have value between 0 and 255 and the neighbor value D can have a value between 0 and 4.

Another innovative aspect of the subject matter described in this disclosure can be implemented as a non-transitory computer readable storage medium comprising instructions that when executed by a processor cause the processor to perform a method for adaptively applying color mapping to display an input image with reduced visible halftone noise on a display device having a plurality of display elements. Each display element is configured to display a plurality of colors in a color space associated with the display device. The image data of the input image comprises a plurality of pixels. Each pixel of the image data is associated with a color value. The method comprises dividing the image data into multiple blocks, each of the multiple blocks including some of the plurality of image pixels. The method further comprises classifying each of the multiple blocks of the image data into one of a plurality of image region types. The classification of each block is based at least partly on color gradients between image pixels in the block. For each image pixel, the method further comprises selecting at least one color mapping parameter for the image pixel based at least partly on the image region type that was classified for a block including the image pixel. The method further comprises determining a mapped color for a color of each of the plurality of pixels using the color mapping parameter selected from the respective image pixel; and displaying the image on the display device using the mapped colors for the image pixels.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A illustrates an example of a constant tone image having 24 bits-per-pixel (bpp). FIG. 5B illustrates the halftoned image of the constant tone image of FIG. 5A having a lower resolution of 6 bpp.

FIG. 6A shows the normalized luminance response of human visual system as a function of angular frequency for an example of a display device with pixel density 200 pixels per inch held at a distance of 12 inches. FIG. 6B shows the normalized chrominance response of human visual system as a function of angular frequency for the same display device as in FIG. 6A.

FIGS. 7A1-7A4 illustrate examples of four continuous tone patches. Each continuous tone patch has a different tone level.

FIGS. 7B1-7B4 illustrate examples of patches obtained when each corresponding continuous tone patch in FIGS. 7A1-7A4 is quantized using halftoning.

FIG. 8 shows a normalized plot of an example of the value of visible halftone error, e, as a function of input tone level (0 through 255) for high resolution grayscale patches displayed on a 6 bits per pixel (bpp) display device.

FIG. 9 is a flowchart of an example of a tone mapping method that can be used to display high resolution input image on a low resolution display device with reduced visible halftone noise.

FIGS. 10A-10E illustrate an example of tone mapping using the method illustrated in FIG. 9.

FIGS. 11A1-11B2 illustrate an example that shows the effectiveness of the tone mapping method in reducing visible halftone noise.

FIG. 12 illustrates an example of the effect of the neighborhood on a halftoned image generated by tone mapping.

FIG. 13A is a flowchart that illustrates an example of an adaptive color mapping method 1400 that can be used to display an input image including a plurality of image pixels on a display device having a plurality of display elements, each display element configured to display a plurality of colors in a color space associated with the display device.

FIG. 13B is a flowchart that illustrates an example method 1450 to divide and classify an input image into multiple blocks as discussed above with reference to logical blocks 1405 and 1410 of the method 1400 of FIG. 13A.

FIGS. 14A and 14B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The systems and methods described herein can be used to display high resolution color images (for example, images having 24 bits per pixel, 8 bits per color channel) on a display device including a plurality of display elements having lower color resolution (for example, 2 or 4 bits per color channel). Each display element in the display device can display a color in a color space associated with the display device with a color resolution associated with a number of bits (for example, 2 or 4 bits). To display high resolution color images (for example, with 8 bits per color channel or 256 color levels per color channel) on a display device having a lower color resolution, a method referred to as color quantization can be used to reduce the number of possible distinct color levels per channel (for example, 256 color levels per channel) in the image to the number of possible distinct color levels that can be produced by the display device (for example, 4 or 16 color levels per channel). Halftoning methods can be used to create the illusion of continuous-tone images using a reduced number of possible distinct color levels.

The color quantization and halftoning processes can be associated with a quantization error that can result in visual artifacts that can degrade the visual quality of the displayed image. For example, color quantized images can appear speckled or grainy due to the visibility of halftone noise (or quantization noise). Generally the visible halftone noise is not uniform for all tone or color levels. Some tone or color levels are more susceptible to visual artifacts arising from visible halftone noise than others. Depending on the display device, certain color levels can display lower halftone noise than other color levels. Quantifying the visibility of halftone noise can allow identification of tone or color levels at which halftone noise will be most visible and also tone or colors levels at which the halftone noise will be least visible. The variation in the visibility of halftone noise can be advantageously used to enhance the visual quality of the displayed images. For example, when displaying an image having a plurality of image pixels on a display device having a plurality of display elements, each display element can be assigned a color value in the color space associated with the display device that has the same perceptual color value as the image pixel and has a lower visible halftone noise. This method of reducing visible halftone noise is referred to as tone mapping. To achieve a visually pleasing image, it can be advantageous to adaptively apply tone mapping to different regions of an image. In adaptive tone mapping, different tone mapping parameters are selected for different regions of the image. For example, a tone mapping parameter for a region of the image that exhibits little to no color gradient between adjacent pixels can be different from a tone mapping parameter for a region of the image that exhibits a color gradient that increases or decreases gradually. Adaptively applying tone mapping based on the color gradient in different regions of an image can reduce visual artifacts such as banding or contouring. Furthermore, this concept can be extended in some implementations to region-dependent color mapping, where, as used herein, a color associated with each of the plurality of image pixels can include at least one of tone, grayscale, hue, chroma, saturation, brightness, lightness, luminance, correlated color temperature, dominant wavelength or a coordinate in the color space.

To reduce visible halftone noise, the systems and methods described herein include determining a plurality of color levels that are in a neighborhood of the color level of the image pixel; identifying from among the determined color levels, the color level that has the lowest visible halftone noise and setting the display element to display the identified color level. A size of the neighborhood about the color level of the image pixel is determined based on the color gradient in different regions of the image.

Particular implementations of the subject matter described in this disclosure can be implemented to realize one or more of the following potential advantages. It is possible to display high resolution continuous-tone digital images on display devices having low native resolution that can display a limited number of tone or color levels by using halftoning to render intermediate tones that cannot be natively displayed by the display device. However, the halftoning process trades-off spatial resolution for tone resolution. For example, if the pixel size of the display device is not small enough to be invisible to the human eye, halftone patterns for various tones generally will be visible. For image content that is smooth (or without texture), the halftone pattern can be perceived as dither noise on a solid background. The systems and methods described herein can advantageously reduce the visible dither noise by determining whether visible halftone noise would be visually perceptible for an input color, and if so, replacing the input color with a color that is perceptually similar but has lower visible halftone noise. The systems and methods described herein can be used to display images that have areas of smooth or constant tones, areas with gradually increasing or gradually decreasing color gradient or areas with texture. Certain implementations of the color mapping scheme discussed herein can be used to display graphic images for use in e-books, e-comics, web-pages and graphical user-interfaces as well as high resolution continuous tone images such as photographs.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

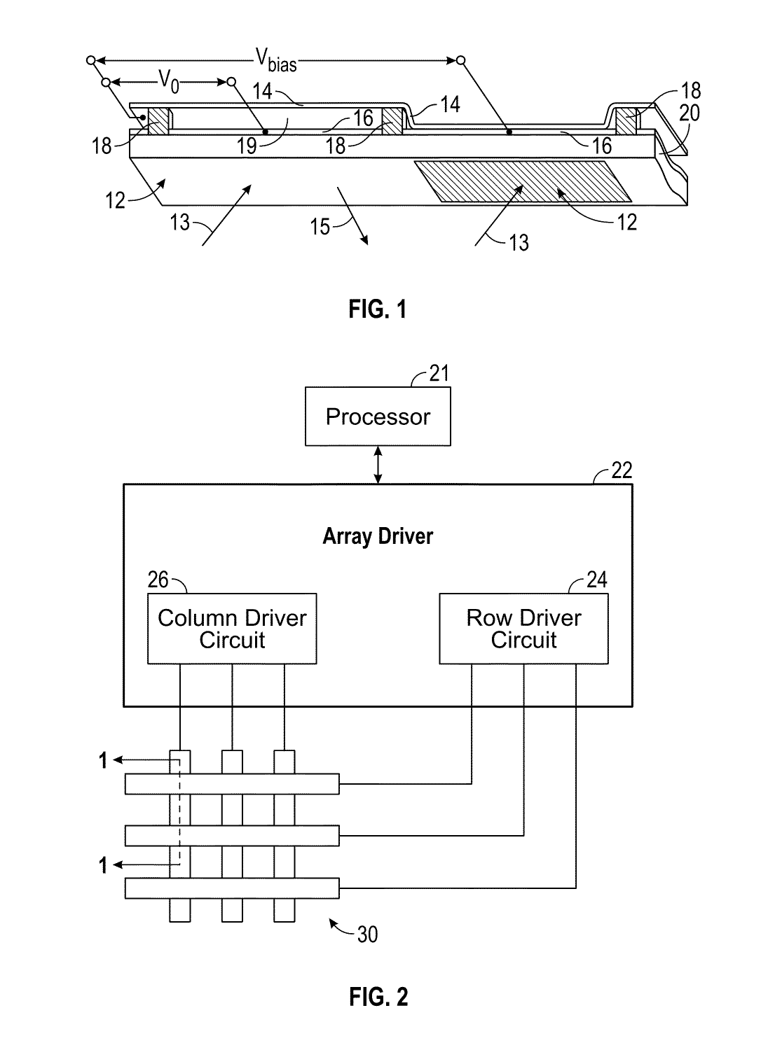

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

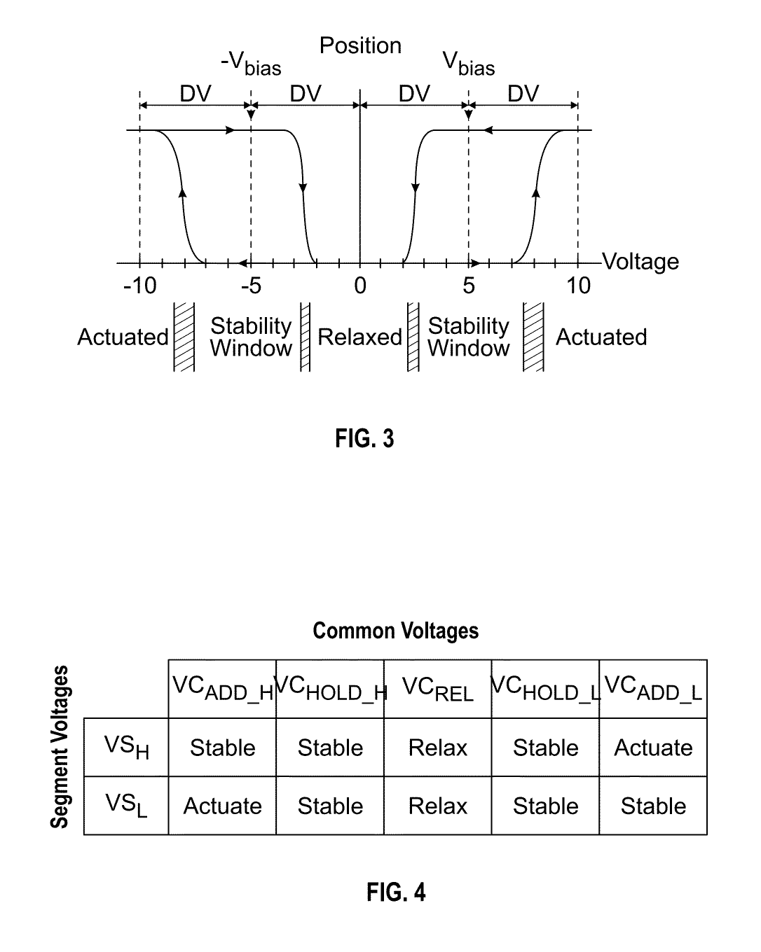

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

In the following example, a display device has a plurality of display elements, and each display element can be either off or on. Such a display device can natively render only tone or color levels of 0 (off) or 1 (on). To render intermediate tone or color levels, a halftoning process can be used wherein a particular tone or color level is reproduced by a halftone pattern which has an average value over a spatial region equal to the desired tone or color level. Several different patterns of 1's and 0's are possible for a particular tone or color level. For example, in one implementation, a tone or color level of 0.5 can be reproduced by turning on 50% of the display elements in a spatial region. Various halftoning algorithms, such as, for example, dither masks, error-diffusion, etc. can be used to find visually pleasing halftone patterns. However, as discussed above, the halftoning process can trade-off spatial resolution for tone or color resolution. For example, if the size of the display element is not small enough to be invisible to the human visual system, halftone patterns for various tone or color levels can be visible. For image content that is smooth or without texture, the halftone pattern can be perceived as foreground noise on a solid background.

Consider an implementation of a reflective display device, such as, for example, the IMOD display device discussed herein, having 6 bits-per-pixel (bpp). Each display element can represent a plurality of colors (for example, red (R), green (G) and blue (B)) in a color space associated with the display device. A color in the color space associated with the display device can represent tone, grayscale, hue, chroma, saturation, brightness, lightness, luminance, correlated color temperature, dominant wavelength, or a coordinate in the color space.

A high resolution input image can be displayed on the implementation of the display device using the halftoning process as discussed above. The high resolution input image includes a plurality of image pixels and each of the plurality of image pixels includes a combination of colors. The color of an image pixel can be represented by coefficients in a coordinate system in a multi-dimensional color space. For example, each image pixel of a digital color image can be represented by a number of coefficients (such as three or four) in a color space (e.g., standard RGB (sRGB) color space, International Commission on Illumination (CIE) XYZ color space, etc.). The coefficients can represent weights or levels for each of the color channels that make up the color space. For example, in various implementations, the coefficients can represent each of the three color channels red (R), green (G), and blue (B) in the sRGB color space. As another example, the coefficients can represent the color channels cyan (C), magenta (M), yellow (Y) and black (K) in a color space that uses CMYK color model.

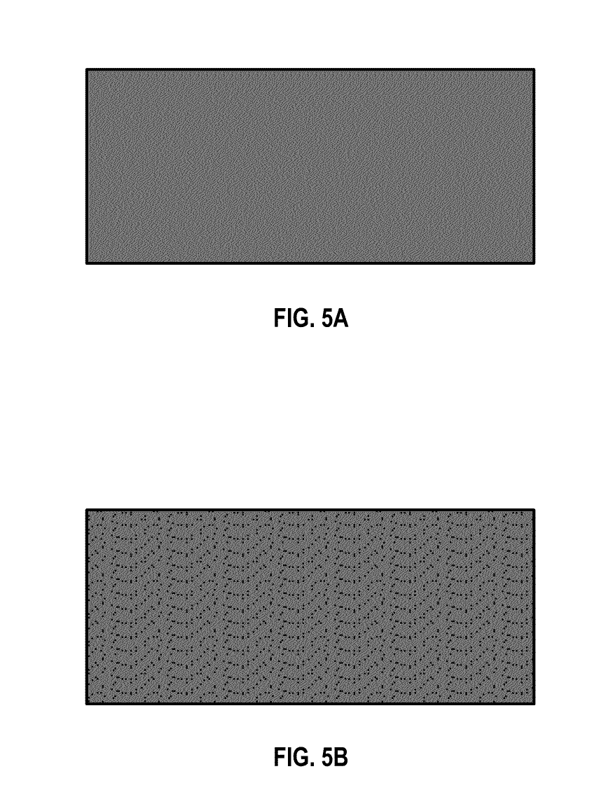

FIG. 5A illustrates an example of a constant tone image having 24 bits-per-pixel (bpp). FIG. 5B illustrates the constant tone image as displayed on a display device having a lower resolution of 6 bpp using halftoning. The input image can be considered to be a three-dimensional (3D) data array with RGB values at each spatial location. The input image can be displayed on the implementation of the reflective display device discussed above by mapping the 3D input image data array onto the plurality of display elements. Mapping the 3D input image array on to the plurality of display elements includes assigning a color value for each pixel in the color space associated with the display device. As observed from FIG. 5B, the halftone pattern appears as noise.

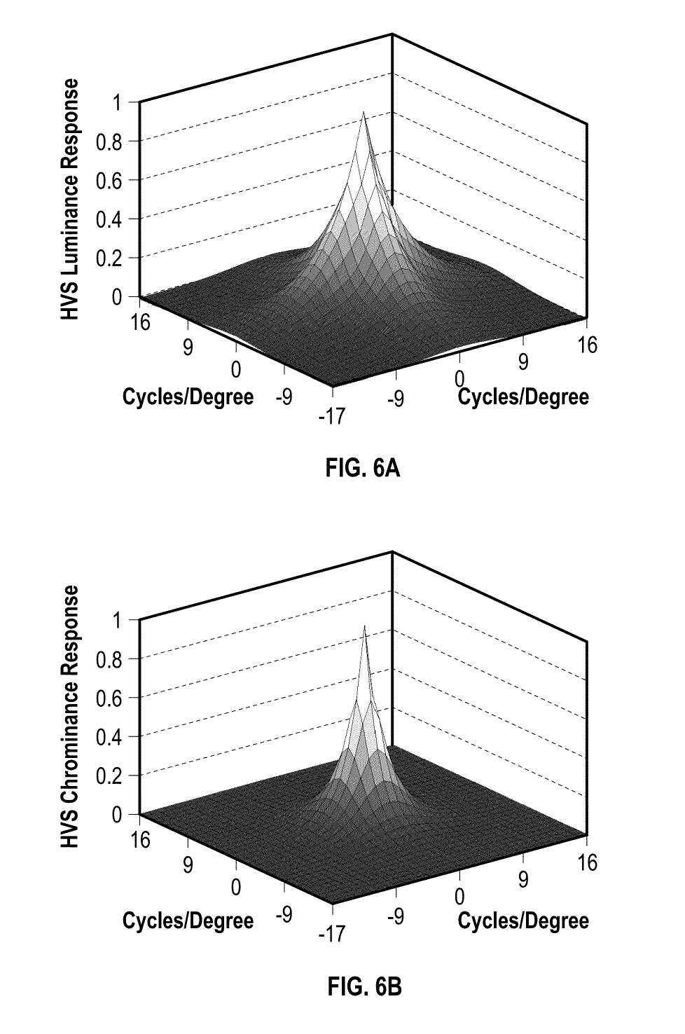

The visibility of halftone noise can be quantified with the help of models of human vision. The human visual system (HVS) response to spatial variations in luminance (brightness) and spatial variations in color components are different. Various methods can be used to describe the luminance response and chrominance response of the eye. FIG. 6A shows the normalized luminance response of human vision as a function of angular frequency for a display device with pixel density 200 pixels per inch held at a distance of 12 inches. FIG. 6B shows the normalized chrominance response of human vision as a function of angular frequency for the same display device as in FIG. 6A. FIGS. 6A and 6B exhibit some general characteristics of the HVS. For example, it can be observed from FIGS. 6A and 6B, that the HVS has a low-pass effect, wherein the HVS response falls off rapidly with increasing spatial frequency. The HVS is also generally less sensitive to chrominance than luminance.

The HVS response function illustrated in FIGS. 6A and 6B can be used to quantify the visible halftone noise. In one example method used to quantify visible halftone noise, x and y represent the colors in continuous tone and halftoned patches respectively, and Hy and Hc represent the luminance and chrominance responses of the HVS respectively. The visible halftone noise can be calculated by converting the continuous tone and halftoned patches in the color space of the display device to a perceptually linear color space (e.g., the linearized CIELab color space), which can be used as a reference. The components of the linearized CIELab color space are one luminance channel and 2 chrominance channels. The visible halftone noise can be represented by a visible halftone error, e. The visible halftone error, e, between the continuous tone and the halftoned patches for vectorized versions of x and y can be calculated from the following equation:

$$e = ‖ HFC ( [ \begin{matrix}{x}_{R} \\ {x}_{G} \\ {x}_{B}\end{matrix} ] - [ \begin{matrix}{y}_{R} \\ {y}_{G} \\ {y}_{B}\end{matrix} ] ) ‖ \qquad ( 1 )$$

where H is a block matrix with the HVS luminance and chrominance responses, and C transforms the display device color space values to linearized CIELab space. The matrix F is the discrete Fourier transform matrix and transforms the color space values to frequency space, because the luminance and chrominance responses (H) are in frequency space. The double vertical bars represent the matrix norm. In some implementations, the visible halftone error, e can be used to measure the dither visibility introduced by halftoning. Higher values of dither visibility represent higher errors perceived by the HVS.

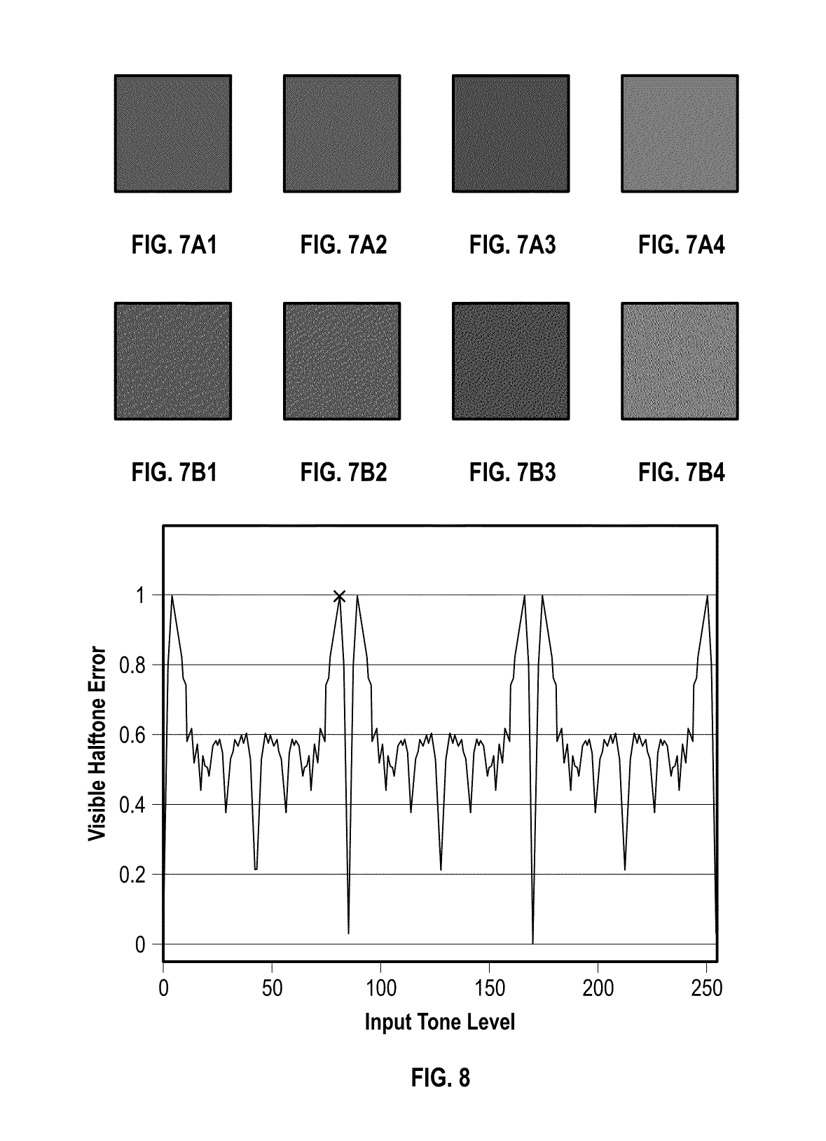

FIGS. 7A1-7A4 illustrate examples of four continuous tone patches. Each continuous tone patch has a different tone or color level. FIGS. 7B1-7B4 illustrate patches obtained when each continuous tone patch in FIGS. 7A1-7A4 is quantized using halftoning. The visible halftone noise is calculated for each patch illustrated in FIGS. 7B1-7B4 using equation (1). The visible halftone error, e for the halftoned patch illustrated in FIG. 7B1 is calculated to be 2.809e+11. The visible halftone error, e for the halftoned patch illustrated in FIG. 7B2 is calculated to be 2.506e+11. The visible halftone error, e for the halftoned patch illustrated in FIG. 7B3 is calculated to be 2.092e+11 and the visible halftone error, e for the halftoned patch illustrated in FIG. 7B4 is calculated to be 1.616e+11. In general, higher values of the visible halftone error, e, can imply higher halftone noise visibility. For example, the halftoned image illustrated in FIG. 7B1 corresponding to the continuous tone image illustrated in FIG. 7A1 shows higher visible halftone noise as compared to the halftoned images illustrated in FIGS. 7B3 and 7B4, which is consistent with the higher value of the visible halftone error, e of 2.809e+11 for the patch in FIG. 7B1.

FIG. 8 shows a normalized plot of an example of the value of visible halftone error, e, as a function of input tone level (0 through 255) for high resolution grayscale patches displayed on a 6 bits per pixel (bpp) display device. It is observed from FIG. 8 that the visible halftone error, e is zero at the four tone levels (0, 85, 170, and 255) for the 6 bpp display device indicating that these tone levels can be exactly represented in the color space associated with the display device. It is further observed from FIG. 8 that the visible halftone error, e, is small (about 0.2) at tone levels between or equidistant from the four tone levels 0, 85, 170 and 255, since these tone levels can be reproduced by a 50% fill of the two tone levels having visible halftone error, e value of zero. This gives a halftone pattern with the highest possible spatial frequency components, which can be the least visible among all halftone patterns.

It is also observed from FIG. 8 that for some tone ranges, there are large differences in halftone noise visibility. For example, the tone level 81 indicated with an ‘x’ mark is associated with a large visible halftone error, e of 1. It is noted that a change of four tone levels, for example, from quantization level 85 to quantization level 81 results in a large increase in the visible halftone error, e (for example, from 0 to 1). This effect can be used to advantage in reducing the visible halftone noise in displayed images. For example, if the tone level 81 is perceptually similar to the tone level 85, such that a perceptual tone difference between tone level 81 and tone level 85 is small (e.g., visually imperceptible), then an input image having tone level 81 can be displayed on the display device as tone level 85 such that the visibility of halftone noise is reduced. In general, the perceptual tone difference depends at least partly on the number of tone levels that can be displayed by the display device, the resolution of the display device and the contrast of the display device.

Described below is an example of a method to use the observations from FIG. 8 that certain tone levels lead to halftone patterns with lower halftone noise visibility than other tone levels in their vicinity. In the method described below, a tone level having a higher visible halftone error, e, is replaced by a tone value that is perceptually similar and has a lower visible halftone error, e. However, if a tone level that is perceptually similar and having a lower visible halftone error, e, cannot be determined then the tone level having a higher visible halftone error, e is not replaced.

The method can be performed on a pixel-by-pixel basis for the input image. Although, certain implementations discussed herein may refer to tone levels, other implementations of the method can be applied to color levels, saturation levels, hue levels, grayscale levels, chroma levels, brightness levels, lightness levels, luminance levels, correlated color temperature levels, dominant wavelength levels, or one or more coordinates in a suitable color space (e.g., the color space of the display device).

### Example Method to Reduce Visible Halftone Noise in Grayscale Images

Let I₀ be the tone level of a pixel in an input grayscale image. In some implementations, the input tone level I₀ can be displayed on a display device with reduced visible halftone noise as follows:
1. Determine a plurality of tone levels I₁-I_{N}, where N can be any whole number (e.g., 1, 2, 3, etc.) in the display device color space that are in the vicinity or a neighborhood of the input tone level I₀. The plurality of tone levels I_{N} can be within a neighborhood around the input tone level I₀, wherein a size of the neighborhood can be given by a neighbor value D. Mathematically, the plurality of tone levels I_{N} can be a part of the set [I₀−D, I₀+D]. In various implementations, the neighbor value D can be a predefined parameter or can be dynamically set based at least partly on the value of the tone level I₀. In various implementations, tone levels are in a range from 0 to 255, and the neighbor value D can have a value between 1 and 255. For example, in some implementations, the neighbor value D can have a value between 1 and 5 such that the plurality of determined tone levels I_{N} are within 5 tone levels on either side of the input tone level I₀. Other values of the neighbor value D can be used such as 6, 7, 8, 9, 12, 15, etc.
2. Calculate the visible halftone error, e(I_{N}), that represents the visible halftone noise for each of the plurality of determined plurality of tone levels in the neighborhood of I₀. The visible halftone error, e(I_{N}) can be calculated using the HVS models discussed above with reference to FIGS. 6A and 6B. In some implementations, equation (1) is used to calculate the visible halftone error, e. In various implementations, the visible halftone error, e(I_{N}) can be calculated using a graph similar to the graph illustrated in FIG. 8.
3. Calculate the perceptual color difference score ΔE(I₀, I_{N}) between the input tone level I₀ and the plurality of determined tone levels I_{N}. The function ΔE(I₀, I_{N}) can be a metric that measures the difference or distance between the input tone level I₀ and the tone level I_{N} in the color space.
4. Identify a plurality of tone levels I_{J} and I_{K} from among the plurality of determined tone level I_{N} that has a perceptual color difference score ΔE less than a perceptual error threshold T and that have a visible halftone error e(I_{J}) and e(I_{K}) less than the visible halftone error e(I₀) that would result if the input tone level I₀ were represented exactly.
5. Select a tone level from among the identified plurality of tone levels I_{J} and I_{K} that has the lowest perceptual color difference score and the lowest visible halftone error.
6. Set the display element to display the selected tone level.

In various implementations, a look up table (LUT) (or other data structure) can be created to store the values of e(I) for all tone levels from 0 through 255 and/or the values of ΔE(I₀, I_{N}). This can advantageously reduce the need for real time computations. The size of the LUT can depend on the magnitude of the neighbor value D. For example, if the neighbor value D is equal to 3, the LUT can be configured to store 256×7 entries, where 256×1 entries can store the visible halftone error values e(I) and 256×6 entries can store the values of ΔE(I₀, I_{N}) in the neighborhood or vicinity of each tone level. In other implementations, e(I) and/or ΔE(I₀, I_{N}) can be represented as mathematical curve fits such as polynomials, splines, rational functions, etc.

The perceptual error threshold T can be based on a just-noticeable-difference (MD) value for the color space. For example, the perceptual error threshold T can be about 1 for the CIELab color space. In implementations where halftone noise is more noticeable (for example, in mobile phone displays or e-readers), color imperceptibility may be relaxed in order to remove more halftone noise. In such implementations, the perceptual error threshold T may be increased so that more potential colors are available for consideration as replacements for the input tone level.

### Example Method to Reduce Visible Halftone Noise in Color Images

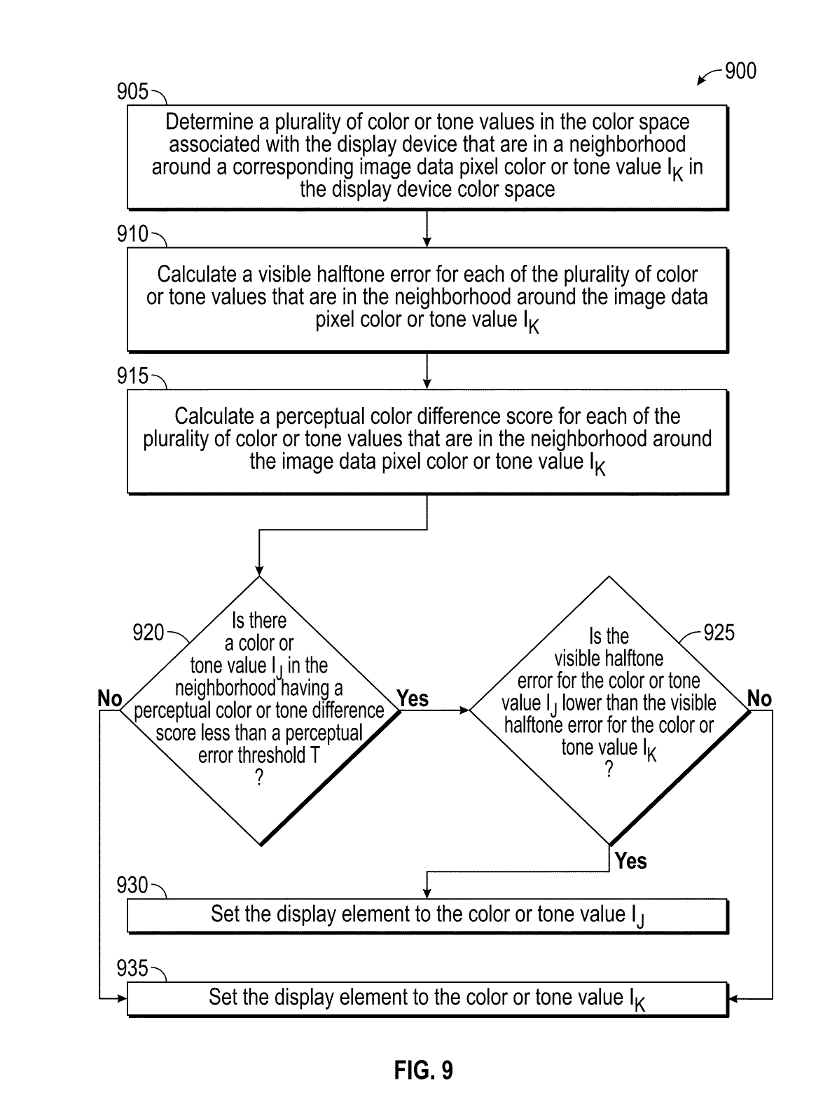

A method to reduce visible halftone noise in color images can be similar to the method to reduce visible color noise for grayscale images discussed above. FIG. 9 is a flowchart of an example of a tone mapping method that can be used to display high resolution input image on a low resolution display device with reduced visible halftone noise (for example, an RGB display device or an IMOD display device described above). The low resolution display device can include a plurality of display elements that are configured to display a plurality of colors in a color space associated with the display device. The input image can include a plurality of image pixels, each image pixel being associated with a color or tone value I_{K} in the display device color space. The method 900 includes determining a plurality of color or tone values in the color space associated with the display device that are in a neighborhood around a corresponding image data pixel color or tone value I_{K}, as shown in logical block 905. The method further includes computing a visible halftone error, e, for each of the plurality of color values that are in the neighborhood around the image data pixel color or tone value I_{K}, as shown in logical block 910. The method includes computing a perceptual color difference score, ΔE, for each of the plurality of color or tone values that are in the neighborhood around the image data pixel color or tone value I_{K}, as shown in logical block 915.

In decision blocks 920 and 925 of the method 900, a color or tone value I_{J} from the plurality of determined color values in the neighborhood having a perceptual color difference score for the color or tone value I_{J} less than a threshold value, T, and having a visible halftone error, e(I_{J}), less than the visible halftone error noise, e(I_{K}) for the image data pixel color or tone value I_{K} is identified. The display element is set to display the color or tone value I_{J}, as shown in logical block 930. In various implementations, if several color or tone values having a perceptual color difference score less than a threshold value, T, and having a visible halftone error less than the visible halftone error noise, e(I_{K}) for the image data pixel color or tone value I_{K} are identified, then the display element is set to display the color or tone value I_{J} that has the lowest visible halftone error, e(I_{J}). If a color or tone value I_{J} having a perceptual color difference score for the color or tone value I_{J} less than a threshold value, T, and having a visible halftone error, e(I_{J}), less than the visible halftone error noise, e(I_{K}) for the image data pixel color or tone value I_{K} is not identified, then the display element is set to the color or tone value I_{K}, as shown in block 935. Although, FIG. 9 illustrates the operation in decision block 920 being carried out before the operation in decision block 925, in some implementations, the operation in decision block 925 can be carried out before the operation in decision block 920.

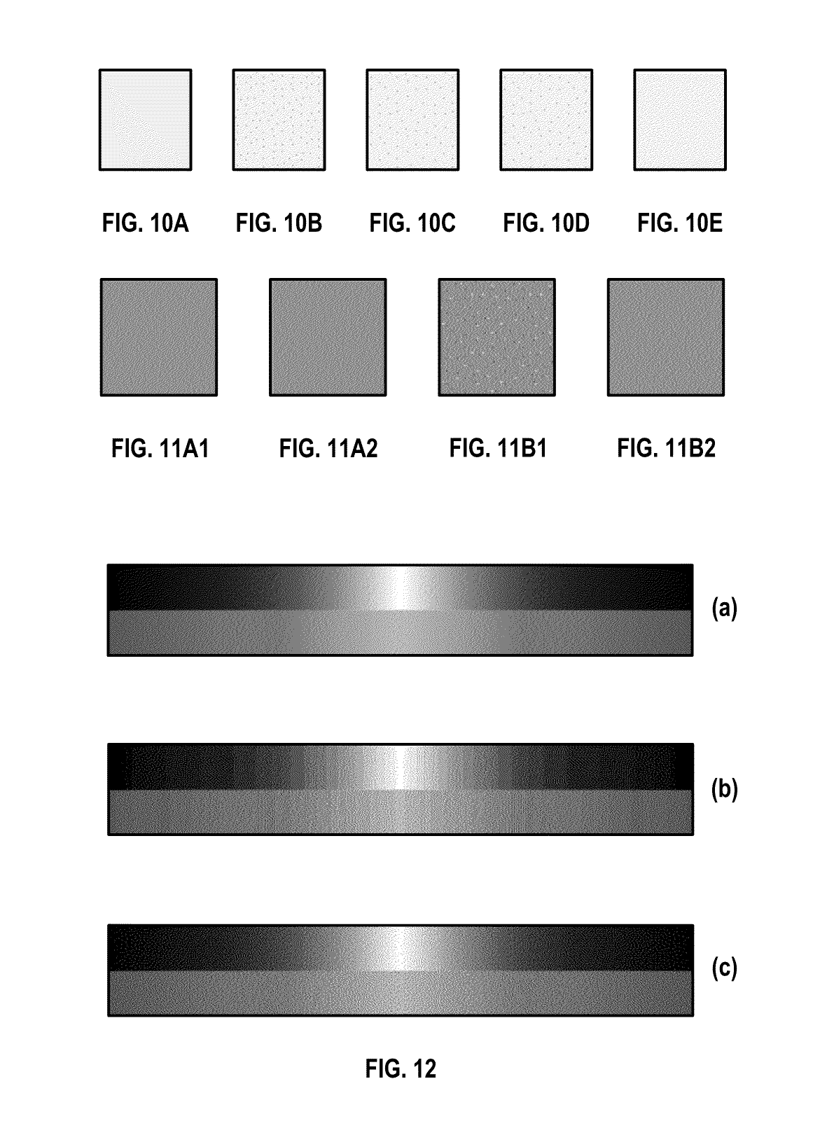

FIGS. 10A-10E illustrate an example of tone mapping using the method illustrated in FIG. 9. FIG. 10A illustrates an input image pixel having a color level I_{K}. FIGS. 10B-10E represent four different color levels I_{J1}, I_{J2}, I_{J3}, and I_{J4} in a color space associated with the display device. The four different color levels I_{J1}, I_{J2}, I_{J3}, and I_{J4} are in a neighborhood of the input color level I_{K} such that the different color levels I_{J1}, I_{J2}, I_{J3}, and I_{J4} are perceptually similar to the input color level I_{K}. The different color levels I_{J1}, I_{J2}, I_{J3}, and I_{J4} can have a value that is in a range between I_{K}−D and I_{K}+D, where D is a neighbor value that determines a size of the neighborhood around the input color level I_{K}. In various implementations, the neighbor value D can be between 0 and 4. In some implementations, the size of the neighborhood can be set by a difference in index sequence numbers. For example, index sequence values J1, J2, J3 and J4 can have values less than or equal to the index sequence value K plus or minus the neighbor value D. For example, the color level I_{J1} can be equal to I_{K±1}, the color level I_{J2} can be equal to I_{K±2}, the color level I_{J3} can be equal to I_{K±3}, and the color level I_{J4} can be equal to I_{K±4}. The visible halftone noise for the color level I_{J1} is represented by FIG. 10B. The visible halftone noise for the color level I_{J2} is represented by FIG. 10C. The visible halftone noise for the color level I_{J3} is represented by FIG. 10D. The visible halftone noise for the color level I_{J4} is represented by FIG. 10E. It is observed from FIGS. 10B-10E that the color level I_{J4} represented by FIG. 10E has the least amount of visible halftone noise. Accordingly, to reduce visible halftone noise in the image displayed by the display device, a region of the incoming image having an input color level I_{K} can be mapped onto the display device by setting corresponding display elements to display the color level I_{J4}, which is perceptually similar to the tone level I_{K} but has lower visible halftone noise.

In contrast to grayscale images, various implementations of color images can have 256×256×256 color levels. In such implementations, a size of the neighborhood can vary as the cube of the neighbor value D. It may not be practical to use a LUT that holds halftone noise error values and perceptual color difference scores for this large number of values. In such implementations, the following method can be used to make computation more practical:
1. The visible halftone noise can be computed in a perceptually linear color space (for example, CIELab space). In such instances, the visible halftone error, e, can be calculated for a color level by separately computing the value of the metric for the three different color planes and then summing the separately computed values. This can allow the use of LUTs to find the values of e(I_{N}) for all color tone levels by using 3 one dimensional LUTs each having 256×1 entries instead of 1 LUT with 256×256×256 entries.
2. The perceptual color difference score can be computed in real time in cases where storing perceptual color difference scores for all possible color tone levels may not be practical.

FIGS. 11A1-11B2 illustrate an example that shows the effectiveness of the tone mapping method in reducing visible halftone noise. FIG. 11A1 illustrates a patch of an input image having color levels [83, 171, 214]. FIG. 11B1 illustrates the corresponding halftoned input image patch as displayed on the display device, when the input color tone levels are mapped exactly onto the display device. FIG. 11A2 illustrates a patch of a modified input image where color levels of the input image are replaced by tone levels in the vicinity of the input color tone levels. The modified input image has color levels [85, 170, 213]. FIG. 11B2 illustrates the corresponding halftoned modified input image patch as displayed on the display device, when the modified input color levels are mapped exactly onto the display device. It is observed from FIG. 11B2 that the halftoned modified input image patch has a lower visible halftone error as compared to the halftoned input image patch shown in FIG. 11B1 and is perceptually similar to the input image depicted in FIG. 11A1.

### Region Dependent Tone Mapping

Although, tone mapping as described above can be advantageous in reducing visible halftone noise, there exists a trade-off in the selection of the neighbor value D that determines a size of the neighborhood from which a mapped color or tone level is selected that is perceptually similar to the color or tone level of the input image pixel I_{K} and has a lower visible halftone noise. For example, large values of the neighbor value D can lead to artifacts since the displayed color or tone level (e.g., I_{J4}) can become less similar to the input color or tone level I_{K}, while small values of the neighbor value D may not reduce visible halftone noise significantly. Moreover, if every image pixel of the incoming image data is mapped onto a display device by setting a corresponding display element to a tone or color level that is selected from a neighborhood that has the same size irrespective of the color gradient between adjacent pixels, the displayed halftoned image can exhibit visual artifacts such as banding, especially if the incoming image data has regions with texture or color gradient that increases or decreases gradually. This is discussed in greater detail below with reference to FIG. 12.

FIG. 12 illustrates an example of the effect of the neighborhood on a halftoned image generated by tone mapping. Panel (a) of FIG. 12 illustrates an incoming image data having various tone or color levels. Panel (b) of FIG. 12 illustrates a halftoned image generated by mapping every image pixel of the incoming image data onto a display device by setting a corresponding display element to a mapped tone or color level that is selected from given by the neighbor value D equal to 4 around the input tone or color level. Panel (c) of FIG. 12 illustrates a halftoned image generated without any tone mapping. In other words, in panel (c) of FIG. 12, every image pixel of the incoming image data is mapped onto a display device by setting a corresponding display element to a tone or color level that is equal to the input tone or color level (i.e, neighbor value D=0). The halftoned image in panel (b) of FIG. 12 appears noisy due to visual artifacts arising from banding. In contrast, the halftoned image in panel (c) of FIG. 12 appears less noisy. It can be inferred from FIG. 12 that selecting the neighbor value D based on image properties, such as, for example, tone or color gradient, can improve the visual quality of halftoned images obtained by tone mapping for certain images. Thus, FIG. 12 indicates the effectiveness of region-dependent tone mapping for a ramp image where the colors are changed gradually.

To understand the effect of the value of the neighbor value D on the visual quality of halftoned images obtained by tone mapping, halftoned images of an input image including texture regions were generated using different values for the neighbor value D in the tone mapping method. Upon analyzing the different halftoned images generated using different values of the neighbor value D, it was observed that some banding occurs in the textured regions. Thus, textured regions of an input image may have a higher visual quality by using tone mapping with a smaller neighbor value D (e.g., 0 or 2) rather than a larger value of D (e.g., 4).

The effect of the value of the neighbor value D on the visual quality of halftoned images obtained by tone mapping based on observations from examples including FIGS. 10A-10D and 12 are summarized below:
1. Smooth and constant regions, such as, for example, the regions illustrated in FIG. 10A show relatively few artifacts for large values of the neighbor value D.
2. Regions with gradual changes (for example ramps) show artifacts (e.g., banding) for large values of the neighbor value D (e.g., 4) as observed from panel (b) of FIG. 12.
3. Regions with texture show few artifacts for small values of the neighbor value D (e.g., 0, 1 or 2) but show artifacts (e.g., banding) for large values of the neighbor value D (e.g., 4 or 5).

Accordingly, to further improve the image quality and avoid potential artifacts, it may be advantageous to select a value for the neighbor value D indicative of the size of the neighborhood for tone mapping adaptively based on the color gradient between adjacent pixels of the incoming image data and/or the textures in the incoming image data. One method of implementing region-type dependent adaptive tone mapping is to apply tone mapping with adaptively selected parameters for different type of regions. Furthermore, the region-type dependent adaptive approach can be extended beyond tone mapping to the more general idea, color mapping. A color mapping method that adaptively applies tone mapping by selecting a neighbor value D for the size of the neighborhood for different regions of the input image is described below.

### Example Method to Apply Adaptive Color Mapping

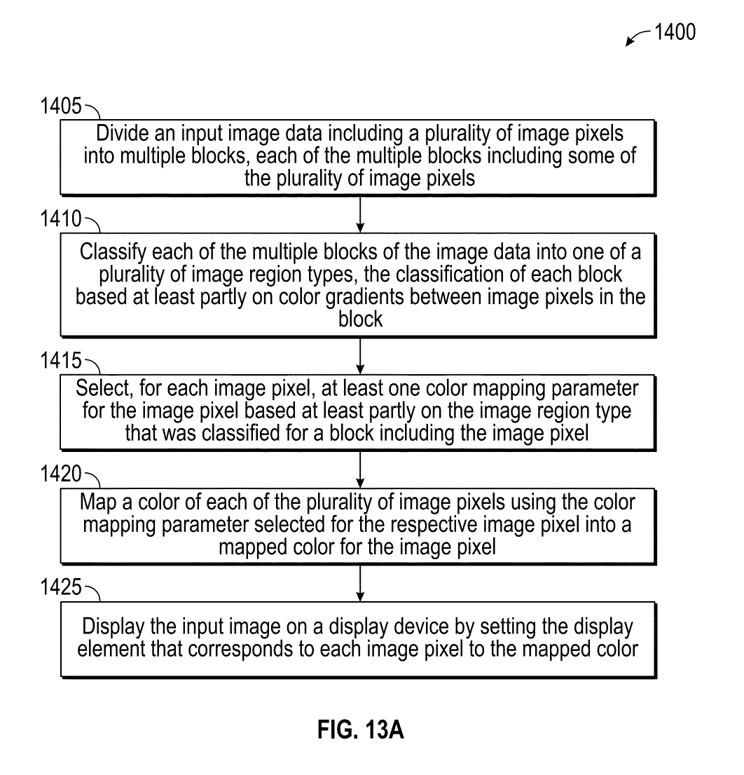

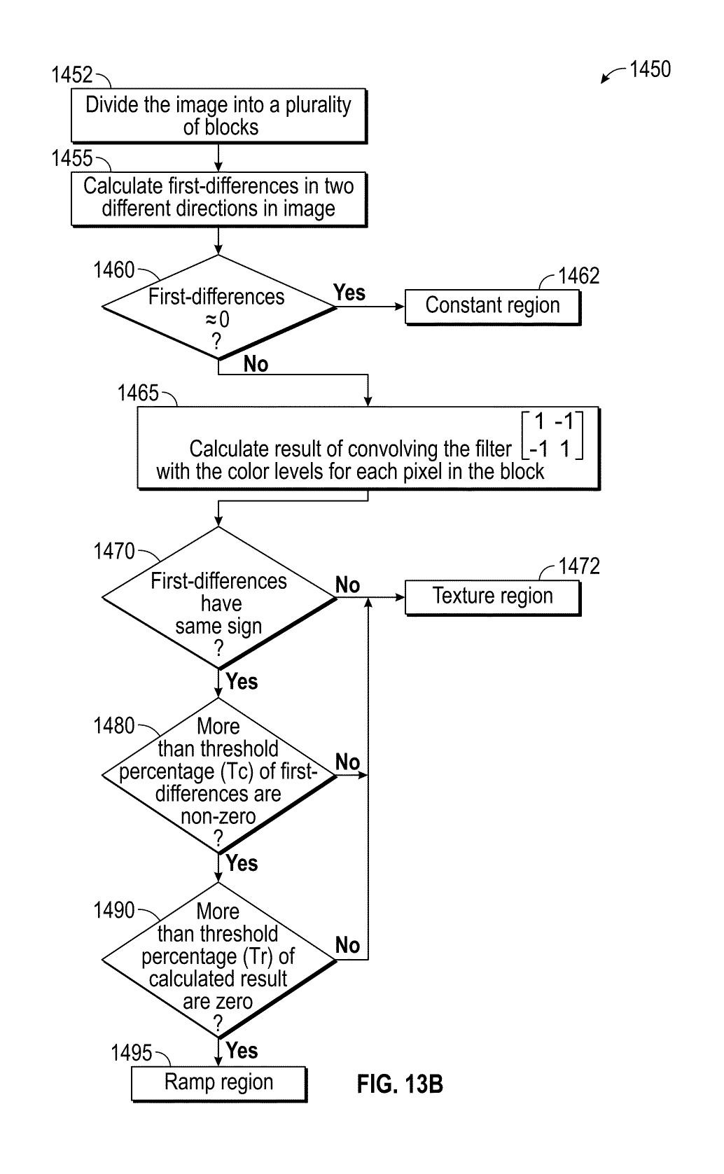

FIG. 13A is a flowchart that illustrates an example of an adaptive color mapping method 1400 that can be used to display an input image including a plurality of image pixels on a display device having a plurality of display elements, each display element configured to display a plurality of colors in a color space associated with the display device. Each of the plurality of image pixels can be associated with a color in the color space associated with the display device. As used herein, a color associated with each of the plurality of image pixels can include at least one of tone, grayscale, hue, chroma, saturation, brightness, lightness, luminance, correlated color temperature, dominant wavelength or a coordinate in the color space. In various implementations, the color associated with each of the plurality of image pixels can have a value between 0 and 255. The method includes dividing the input image into multiple blocks as shown in logical block 1405. Each of the multiple blocks includes one or more of the plurality of image pixels. For example, the blocks can be 3×3, 5×5, 4×6, 8×4, or 9×9 blocks of pixels from the input image. In some implementations, each of the multiple blocks can be equal-sized. In other implementations, the size of some of the multiple blocks can be different from the size of some other blocks.

Each of the multiple blocks of the input image is classified into one of a plurality of image region types based at least partly on color gradients between image pixels in that block, as shown in logical block 1410 of the method 1400 of FIG. 13A. For example, in some implementations, each of the multiple image blocks can be classified as a constant region, a ramp region or a texture region. In a block classified as a constant region, there may be little to no color gradient between adjacent pixels. In other words, the color gradient between adjacent pixels in a block classified as a constant region can be approximately 0. In a block classified as a ramp region type, the color gradient between adjacent pixels either gradually increases or gradually decreases. In other words, the color gradient between adjacent pixels in a block classified as a ramp region is non-zero and has the same sign (positive or negative). If a block is not classified as a constant region or a ramp region, then it is classified as a texture region. In a block classified as a texture region, there can be large variations in the color gradient between adjacent pixels. An example method 1450 of classifying the multiple blocks is described in detail below with reference to FIG. 13B.

For each image pixel in a block, at least one color mapping parameter is selected based at least partly on the classification of that block, as shown in logical block 1415 of the method 1400. For example, if a pixel belongs to a block classified as a constant region, then the color mapping parameter is selected to have a first value. As another example, if a pixel belongs to a block classified as a ramp region, then the color mapping parameter is selected to have a second value. As yet another example, if a pixel belongs to a block classified as a texture region, then the color mapping parameter is selected to have a third value. The first value, the second value, and the third value can, but need not, be different from each other.

Each of the plurality of image pixels is mapped into a mapped color by using the color mapping parameter selected for that image pixel, as shown in logical block 1420 of the method 1400. In various implementations, the color mapping parameter can be the neighbor value D which determines the size of the neighborhood around the color of the image pixel from which the mapped color is chosen. As discussed above, the neighbor value D can be selected to have different values for different image region types. For example, the neighbor value D can be equal to 4 or 5 for a block classified as a constant region. As another example, the neighbor value D can be equal to 0 for a block classified as ramp region. As yet another example, the neighbor value D can be equal to 1 for a block classified as a texture region. The values for the neighbor value D can depend at least partly on the color space of the image. The values for the neighbor value D can be determined by performing empirical studies using viewers who judge the quality of the image for different values of the neighbor value D. In various implementations, the neighbor value D can represent a distance in the color space associated with the display device.

In implementations wherein the color mapping parameter is the neighbor value D, each image pixel is mapped into a mapped color by identifying a color in the color space associated with the display device within a neighborhood having a size given by the neighbor value D selected for that image pixel that is (a) is perceptually similar to the color of the image pixel; and (b) has a halftone noise visibility that is less than a halftone noise visibility of the color of the image pixel. In this manner, color mapping method is applied adaptively to different types of regions of the input image. The adaptively tone mapped image can be displayed on the display device by setting the display element that corresponds to each image pixel to the mapped color. Temporal dithering, spatial dithering, and/or error diffusion can be applied to the mapped colors to further improve the visual quality of the displayed image.

Example Method to Classify Multiple Image Blocks based on Region Type

FIG. 13B is a flowchart that illustrates an example method 1450 to divide and classify an input image into multiple blocks as discussed above with reference to logical blocks 1405 and 1410 of the method 1400 of FIG. 13A. In the implementation of the method 1450, the input image is divided in to a plurality of blocks, as shown in logical block 1452 of FIG. 13B. For example, an extended graphics array (XGA) images including 1024×768 image pixels can be divided into multiple blocks, each block having a size of 5×5 pixels. In other implementations, the plurality of blocks can have different sizes (e.g. 3×3 pixels, 7×7 pixels) than in this example. With reference to FIG. 13B, each of the plurality of blocks can be classified into various regions as follows:
1) Detect whether a block is a constant region by:
   a. Calculating the first-difference (or gradient) in two different directions (e.g., both the horizontal and vertical directions), as shown in logical block 1455 of FIG. 13B. The first-difference can be calculated by convolving the color levels for each pixel in the block with the filters [−1 1] and

$$[ \begin{matrix}- 1 \\ 1\end{matrix} ] ,$$

respectively.
b. Classifying the block as a constant region if the first-differences of all pixels in a block are equal to approximately 0, as shown in decision block 1460 and logical block 1462 of FIG. 13B. For example, in various implementations, a block can be classified as a constant region if all the pixels in a block have a value less than or equal to 0.1. In various implementations, how close to 0 should the first differences be in order for a block to be classified as a constant region can depend on the contrast ratio of the display device.
2) Detect whether a block is a ramp region by:
   a. Calculating the result of convolving the filter

$$[ \begin{matrix}1 & - 1 \\ - 1 & 1\end{matrix} ]$$

with the color levels for each pixel in the block, as shown in the logical block 1465 of FIG. 13B. In some implementations, a block satisfying all the following conditions is classified as the type of ramp region, as shown in logical block 1495 of FIG. 13B:
   i. All first-differences along a direction have the same sign (either positive or negative), as shown in logical block 1470 of FIG. 13B.
   ii. More than a threshold percentage (T_{c}) of the first-differences are non-zero, as shown in logical block 1480 of FIG. 13B. The threshold percentage (T_{c}) can be a pre-defined parameter. In various implementations T_{c} can have a value between about 5% and about 90%. In various implementations, T_{c} can have a value less than or equal to about 10%, less than or equal to about 20%, less than or equal to about 30%, less than or equal to about 40%, less than or equal to about 50%, less than or equal to about 60%, less than or equal to about 70%, less than or equal to about 80%, or less than or equal to about 90%.
   iii. More than a threshold (percentage) (Tᵣ) of the calculated result are 0, as shown in logical block 1490 of FIG. 13B. The threshold percentage (Tᵣ) can be a pre-defined parameter. In various implementations Tᵣ can have a value between about 5% and about 90%. In various implementations, Tᵣ can have a value less than or equal to about 10%, less than or equal to about 20%, less than or equal to about 30%, less than or equal to about 40%, less than or equal to about 50%, less than or equal to about 60%, less than or equal to about 70%, less than or equal to about 80%, or less than or equal to about 90%.
3) If a block doesn't belong to the category of constant regions or the category of ramp regions, the block is classified as a texture region, as shown in logical block 1472 of FIG. 13B.

In various implementations, to reduce computation, the input image or some of the multiple blocks can be converted to grayscale prior to classification. In some implementations, each color plane of a color input image can be classified separately. For example, for an RGB input image, the R, G and B color planes can be classified independently from each other.

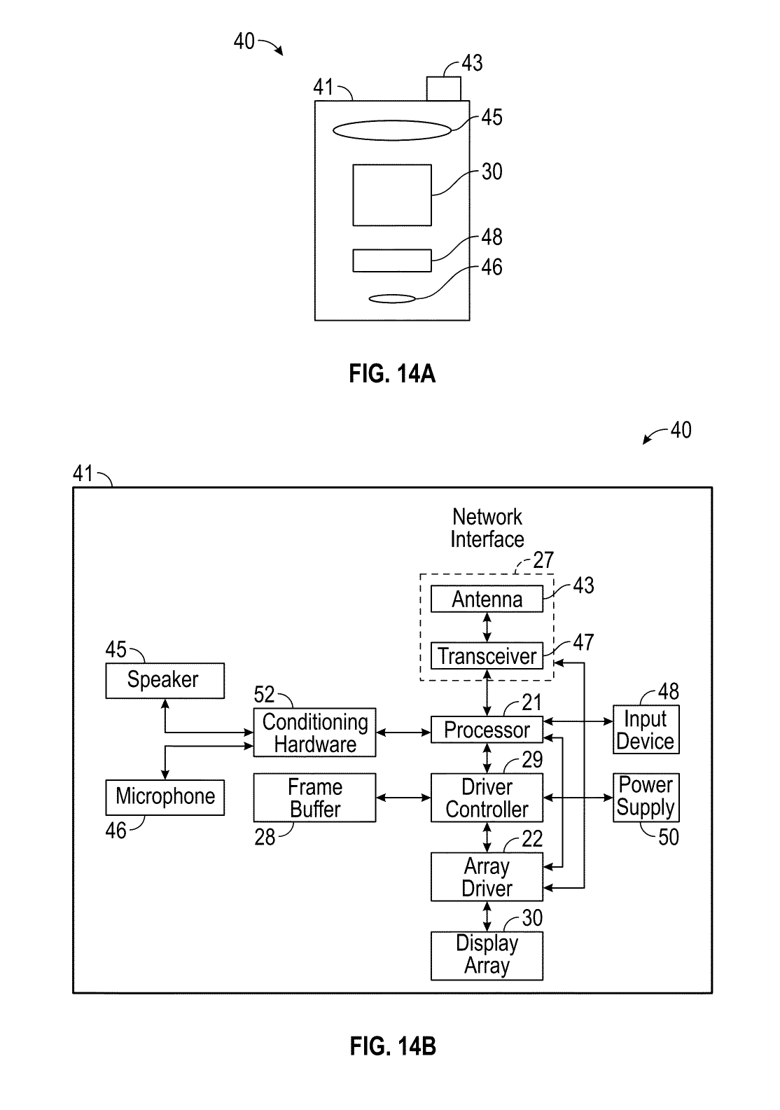

In various implementations, the methods 900, 1400, and 1450 can be performed by a hardware processor included in the display device (for example, the processor 21, the driver controller 29, and/or the array driver 22 described below with reference to the display device 40 of FIGS. 14A and 14B). To perform the methods 900, 1400, or 1450, the processor can execute a set of instructions stored in one or more non-transitory computer readable storage media (such as those described in more details below). The processor can access a computer-readable medium that stores the dither visibility and/or perceptual color difference, for example, as one or more LUTs. In various implementations, the processor can include an accumulator and/or a comparator.

FIGS. 14A and 14B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein. In various implementations the display 30 can be a RGB display device or a reflective display device.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. In various implementations, the processor 21 can be configured to implement the methods illustrated by flowchart 1000. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and grayscale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described methods for adaptively applying color mapping may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus capable of adaptive color mapping, the apparatus comprising:
a display device including a plurality of display elements, each display element configured to display a plurality of colors in a color space associated with the display device; and
a processor configured to communicate with the display device, the processor configured to process image data of an image for display by the display device, the image data including a plurality of image pixels, each of the image pixels being associated with a color value, the processor configured to:
divide the image data into multiple blocks, each of the multiple blocks including some of the plurality of image pixels;
classify each of the multiple blocks of the image data into one of a plurality of image region types, the classification of each block based at least partly on color gradients between image pixels in the block;
select, for each image pixel, at least one color mapping parameter for the image pixel based at least partly on the image region type that was classified for a block including the image pixel;
determine a mapped color for a color of each of the plurality of pixels using the color mapping parameter selected for the respective image pixel; and
display the image on the display device using the mapped colors for the image pixels.

2. The apparatus of claim 1, wherein to display the image, the processor is configured to apply a halftoning algorithm to the mapped colors.

3. The apparatus of claim 1, wherein the mapped color is perceptually similar to the color and has a halftone noise visibility that is less than a halftone noise visibility of the color.

4. The apparatus of claim 3, wherein the mapped color is within a neighborhood of the color in the color space, wherein the neighborhood has a size equal to a neighbor value D.

5. The apparatus of claim 4, wherein the color mapping parameter includes the neighbor value D.

6. The apparatus of claim 4, wherein the color has a value between 0 and 255 and the neighbor value D has a value between 0 and 4.

7. The apparatus of claim 1, wherein the color can represent at least one of: tone, grayscale, hue, chroma, saturation, brightness, lightness, luminance, correlated color temperature, dominant wavelength and a coordinate in the color space.

8. The apparatus of claim 1, wherein each of the multiple blocks has the same size.

9. The apparatus of claim 1, wherein the multiple blocks include at least some blocks having a size of 5×5 pixels.

10. The apparatus of claim 1, wherein as the image region types include a constant region, a ramp region, and a texture region.

11. The apparatus of claim 10, wherein a block is classified as a constant region if the color gradients in the block are zero.

12. The apparatus of claim 10, wherein a block is classified as a ramp region if the color gradients in the block are non-zero and have the same sign.

13. The apparatus of claim 10, wherein a block is classified as a texture region if the block is not classified as a constant region or a ramp region.

14. The apparatus of claim 10, wherein the color has a value between 0 and 255, and the mapped color is within a neighborhood of the color, and wherein a size of the neighborhood is equal to 4 in the constant region, or a size of the neighborhood is equal to 0 in the ramp region, or a size of the neighborhood is equal to 1 in the texture region.

15. The apparatus of claim 1, further comprising a memory device that is configured to communicate with the processor.

16. The apparatus of claim 15, further comprising a driver circuit configured to send at least one signal to the display device.

17. The apparatus of claim 16, further comprising a controller configured to send at least a portion of the image data to the driver circuit.

18. The apparatus of claim 1, further comprising an image source module configured to send the image data to the processor.

19. The apparatus of claim 18, wherein the image source module includes at least one of a receiver, transceiver, and transmitter.

20. The apparatus of claim 1, further comprising an input device configured to receive input data and to communicate the input data to the processor.

21. A method for adaptively applying color mapping to display an input image with reduced visible halftone noise on a display device having a plurality of display elements, each display element configured to display a plurality of colors in a color space associated with the display device, the image data of the input image comprising a plurality of pixels, each pixel of the image data being associated with a color value, the method comprising:
dividing the image data into multiple blocks, each of the multiple blocks including some of the plurality of image pixels;
classifying each of the multiple blocks of the image data into one of a plurality of image region types, the classification of each block based at least partly on color gradients between image pixels in the block;
selecting, for each image pixel, at least one color mapping parameter for the image pixel based at least partly on the image region type that was classified for a block including the image pixel; and
determining a mapped color for a color of each of the plurality of pixels using the color mapping parameter selected from the respective image pixel; and
displaying the input image on the display device using the mapped colors for the image pixels,
wherein the method is performed in its entirety by a physical computing device.

22. The method of claim 21, wherein the mapped color is perceptually similar to the color and has a halftone noise visibility that is less than a halftone noise visibility of the color.

23. The method of claim 22, wherein the mapped color is within a neighborhood of the color in the color space, wherein the neighborhood has a size equal to a neighbor value D.

24. The method of claim 23, wherein the color mapping parameter includes the neighbor value D.

25. The method of claim 23, wherein the color has a value between 0 and 255 and the neighbor value D has a value between 0 and 4.

26. A non-transitory computer readable storage medium, comprising instructions that when executed by a processor cause the processor to perform a method for adaptively applying color mapping to display an input image with reduced visible halftone noise on a display device having a plurality of display elements, each display element configured to display a plurality of colors in a color space associated with the display device, the image data of the input image comprising a plurality of pixels, each pixel of the image data being associated with a color value, the method comprising:
dividing the image data into multiple blocks, each of the multiple blocks including some of the plurality of image pixels;
classifying each of the multiple blocks of the image data into one of a plurality of image region types, the classification of each block based at least partly on color gradients between image pixels in the block;
selecting, for each image pixel, at least one color mapping parameter for the image pixel based at least partly on the image region type that was classified for a block including the image pixel; and
determining a mapped color for a color of each of the plurality of pixels using the color mapping parameter selected from the respective image pixel; and
displaying the input image on the display device, the displayed image using the mapped colors for the image pixels.

27. The non-transitory computer storage of claim 26, wherein the mapped color is perceptually similar to the color and has a halftone noise visibility that is less than a halftone noise visibility of the color.

28. The non-transitory computer storage of claim 26, wherein the mapped color is within a neighborhood of the color in the color space, wherein the neighborhood has a size equal to a neighbor value D.

29. The non-transitory computer storage of claim 28, wherein the color mapping parameter includes the neighbor value D.

30. The non-transitory computer storage of claim 28, wherein the color has a value between 0 and 255 and the neighbor value D has a value between 0 and 4.
